(19) United States
(12) Patent Application Publication
(10) Pub. No.: US 2012/0053979 A1
(43) Pub. Date: Mar. 1, 2012

(54) METHOD OF MONITORING EQUIPMENT/S OVER AN INSTALLED BASE FOR IMPROVING THE EQUIPMENT DESIGN AND PERFORMANCE

(75) Inventor: Abhay Nalawade, Pune (IN)

(73) Assignee: ECOAXIS SYSTEMS PVT. LTD., Pune (IN)

(21) Appl. No.: 13/318,578

(22) PCT Filed: Apr. 26, 2010
(86) PCT No.: PCT/IN10/00260

§ 371 Date: Nov. 2, 2011

(30) Foreign Application Priority Data
May 4, 2009 (IN) 1160/MUM/2009

(51) Int. Cl. G06Q 10/06

(52) U.S. Cl. 705/7.23

(57) ABSTRACT

Method for improving/optimizing equipment design for an installed base of engineering equipment and for managing equipment operation is disclosed. In one instance, the method includes continuously acquiring, utilizing acquisition systems, (measurements) data for equipment operating conditions, equipment environment conditions, energy consumed by the equipment, utilities consumed b\ the equipment, wastages resulting from the process, input data and output data of each one of a number of pieces of equipment, each one piece of equipment—belonging to an installed base of the same class equipment pieces, and analyzing, utilizing one or more processors, the acquired data in order to obtain patterns and relations for the installed base; the patterns and relations comprising factors that affect performance and efficiency, the patterns and relations being used for equipment design improvement/optimization and installed base management. In one instance, the method also includes recording (storing) the analysis results and providing the analysis results in multiple formats to desired stakeholders, such as original equipment manufacturers (OEMs) the format being customized to the intended recipient/stake-holder.

### FIELD OF INVENTION

This invention relates generally to a method of monitoring equipment over an installed base for improving the design and performance of the equipment/s. More particularly, the invention relates to a method of monitoring equipment/s over an installed base for improving the design and performance of the equipment/s, wherein the equipment/s belong to the same class.

### BACKGROUND AND PRIOR ART

For any manufacturing process, the equipment operational expenses form a significant portion of the total operational expenses. Therefore, optimal performance of the equipment has a direct relation with the cost of the products manufactured by that equipment.

Equipment performance is not constant and unchanging; many factors such as operating environment, conditions, quality and specific characteristics of the utilities, quality of the raw materials etc. cause the performance or efficiency of the equipment to drift from its optimum or design reference levels.

Monitoring a single process or a single instance of equipment does not allow for discovery of the factors that influence the equipment design and performance. Equipment experts (Original Equipment Manufacturers—OEMs) do not currently have access to all of the field data that would influence the equipment design and performance.

As a result of this non-availability of the actual field data from across the installed base, a designer is compelled to compromise and base the equipment design on past experience, assumptions, model-based simulations etc. (instead of on actual field data). Further, OEM field service personnel provide after sales service to end user without having complete data as well.

Conventional methods of obtaining data (of equipment operational conditions, inputs and energy supplied, operations and maintenance procedures applied, applications specific configuration of equipment), on which models are based, are the following:
1. Alpha and beta (field) testing with partially or fully instrumented test equipment;
2. Post product launch surveys and sampling, of field data;
3. Data pulled out from commissioning, trouble-shooting and overhauling reports etc.

Major disadvantages of the conventional methods of data collection and analysis include the following:
a. The data thus acquired is limited in scope;
b. Data and observations can be corrupted with human bias;
c. Sample data is available only for limited time-periods (over which testing and surveys are conducted);
d. Sample data is usually not collected across all instances of installed equipment. It may not be practical or feasible to collect data across all installed instances—e.g. if a tap point is not provided at the time of manufacturing an equipment, it may not be possible to get a measure of bearing temperature (without some or the other extent of equipment retrofit, or in some cases even that might not be an option);
e. Data acquisition is based on known patterns, existing or assimilated knowledge;
f. Specific and explicit efforts are required to maintain consistency and parity in the data captured by the sampling/testing method (across different installation, operating conditions, user segments etc.). If this is not done, sampling data fed into modelling tools (or other statistical analysis tools such as MATLAB) can produce unreliable results;
g. Interpretation of sample data is limited to the extent expertise involved at specific instance of analysis;
h. Expertise for correct analysis and interpretation of sample data may span across several domains and all of the domain experts may or may not look at the same set of data. The only way to overcome this problem is field visits by the experts, which is not always feasible or affordable;
i. Sample data has to be pro-actively obtained as it is not automatically & continuously acquired, analyzed or interpreted.

Equipment design is primarily done on basis of certain assumptions related to
(i) the conditions in which the equipment is operated,
(ii) the characteristics of inputs provided to the equipment,
(iii) the characteristics of the output produced by the equipment,
(iv) the operations and maintenance practices followed in the use of the equipment.

The effects of variances in these assumptions on equipment performance are not available to the equipment manufacturer on continuous basis, using the current available solutions. As a result, currently desired changes in the design of equipment are undertaken only on the basis of field service feedback. However, such feedbacks are based on individual unit observation, summation and interpretations by the team of service people. Further, the effect of many of the variations in relevant parameters cannot be captured accurately by prior art means. Thus they are not comprehensive and result in many iterations before these are stabilized. As such, the changes are costly and are of long cycle. Even if the equipment owner is an expert in the application of equipment to a specific process, but he cannot utilize the field data available to him, as, unlike the equipment manufacturer, he does not design the equipment. Whereas, the equipment manufacturer, who has the design expertise, cannot improve the designing and manufacturing methods, as the field data is not available to him, unlike the equipment owner. Therefore, there is a need that this gap is bridged, and the equipment performance data is provided to the equipment manufacturer fairly continuously, in order to facilitate continuous improvements in the equipment design. The primary necessity for achieving this is having a system of continuous monitoring of the equipment (and further thereto, to record and provide the data to the manufacturer on a continuous basis; to manage the individual equipment etc.). However, the monitoring solution itself has to be efficient in order to ensure that the benefits of monitoring measure favourably against the cost of data acquisition and analysis.

### DESCRIPTION OF RELATED ART

Current equipment management solutions are based on control or process automation, with the following characteristics:
Process automation or automated control systems manage or control the operations of manufacturing processes, and equipment monitoring is an indirect non-primary function of these solutions.
These solutions monitor only those parameters of equipment that are relevant from the perspective of controlling process or equipment operations.
There are several solutions available that automate the equipment/asset management and maintenance processes. Only some of these solutions are designed to make use of equipment health data, and within these, only a few support the feature of directly acquiring equipment health data. For example, U.S. Pat. No. 6,871,160 discloses condition monitoring and maintenance planning for a machine or piece of equipment. Even in these cases, the usual interfaces provided are to automation/control systems. Most of these solutions are designed to be used by asset owners and not by equipment manufacturers. Similarly, process automation or equipment control systems also provide some monitoring capabilities but a comprehensive monitoring solution that is aimed at equipment manufacturers and focused on delivering design improvements through performance management of installed base is not available currently.
Most of these solutions are designed to be used by equipment owners.
Some of these solutions are designed to be used by equipment suppliers or service technicians but conventional solutions (such as the ones discussed in U.S. Pat. No. 6,999,903) report data only for error events deemed to be of importance.
Thus, the currently available solutions fall short of providing the true and complete picture of the equipment operation and performance to the OEM as regards the design specifications and the effect of variations in relevant factors that influences the performance of the equipment over equipment life cycle or a shorter period thereof.

Thus, a single comprehensive solution that maximizes the value of continuously monitoring and real time analysis across different stakeholders is not available. There is, accordingly, a need for a monitoring method that monitors the performance of equipments on a continuous basis, analyzes the data obtained by the monitoring, and provides the same to the various stakeholders on a continuous basis, including the equipment manufacturers, in order to enable continuous design improvements and management of the equipment installed base by predicting and preventing failures and breakdown in the equipment.

### OBJECT OF THE INVENTION

The present invention proposes to meet the needs identified in the above description of the related art as well as meeting other needs as stated below.

The principal object of the invention is to fulfil a need to provide a solution that performs ongoing and continuous monitoring of a plurality of equipments for performance and operational parameters, the equipments including those located at multiple geographical locations, in order to provide equipment performance data to the desired stakeholders (including the equipment manufacturer and designer, the service personnel etc.) in order to:
enable continuous improvements in equipment design;
enable verification of equipment functionality as per the design specifications across the equipment life cycle in a reliable and consistent manner;
optimize equipment performance by establishing patterns and correlations that can lead to predictions and preventions of failures and inefficiencies;
maximize the intelligence that can be gained out of analysis of the performance data acquired from an installed base of the equipment.
communicate the results of analysis of the equipment performance data to various stakeholders such as equipment designers, service personnel, operators, repair personnel etc., who can benefit from such information to create a feedback loop of continuous design and performance improvements.

Another object of the invention is to acquire automatic as well as manual data and to transmit the same via multiple modes (thereby ensuring the transmission even if one of the modes fails) through devices that need not be high-end devices.

### STATEMENT OF THE INVENTION

A method for improving equipment design for equipment installed base is provided, the method comprising the steps of
i. Acquiring a plurality of pre-defined parameters, of each one of a plurality of pieces of equipment located at multiple defined geographic locations, each one piece of equipment from said plurality of pieces of equipment belonging to the installed base of a same class equipment;
ii. Communicating by way of a communication network the acquired data to a remote system, the remote system comprising at least one of computer readable means such as data server application server;
iii. Analyzing, utilizing one or more processors, the acquired data in order to obtain patterns and relations for each of the said plurality of pieces of equipment;
iv. Recording results of analysis; and
v. Providing the analysis results to at least one desired stakeholders; the patterns and relations being used to enable continuous improvements in the design of class of equipment.

A method for improving operation, reliability, maintenance and service for equipment installed base is also provided, the method comprising the steps of
i. Acquiring a plurality of pre-defined parameters, of each one of a plurality of pieces of equipment located at multiple defined geographic locations, each one piece of equipment from said plurality of pieces of equipment belonging to the installed base of a same class equipment;
ii. Communicating by way of a communication network the acquired data to a remote system, the remote system comprising at least one of computer readable means such as data server, application server;
iii. Analyzing, utilizing one or more processors, the acquired data in order to obtain patterns and relations for each of the said plurality of pieces of equipment;
iv. Recording results of analysis; and
v. Providing the analysis results to at least one desired stakeholders; said patterns and relations being used for optimizing equipment performance including operation, reliability, maintenance and service.

### BRIEF DESCRIPTION OF THE DRAWINGS

FIG. 1 is a schematic block diagram reflecting the input/output representation of an embodiment of the system of these teachings.

FIG. 2 is a schematic flowchart representation of an embodiment of the method of these teachings.

FIG. 3 is a schematic flowchart representation of one portion of an embodiment of the method of these teachings.

FIG. 4 is a schematic block diagram of an embodiment of the system of these teachings.

FIG. 5 is another schematic block diagram of an embodiment of the system of these teachings.

### DETAILED DESCRIPTION OF THE EMBODIMENTS

A method for improving equipment design for equipment installed base is provided. A method for improving operation, reliability, maintenance and service for equipment installed base is also provided herein below.

The management of the equipment operation (including improving/optimizing equipment design for an installed base of engineering equipment, hereinafter referred to as managing equipment operation) can include optimizing equipment performance by establishing patterns and correlations that can lead to predictions and preventions of failures and inefficiencies and improvements in equipment design.

The method of these teachings includes continuously acquiring, utilizing acquisition systems, data for inputs, outputs and energy consumption of each one of a number of pieces of equipment, each one piece of equipment belonging to an installed base of a same class of equipment and analyzing, utilizing one or more processors, the acquired data in order to obtain patterns and relations for the installed base.

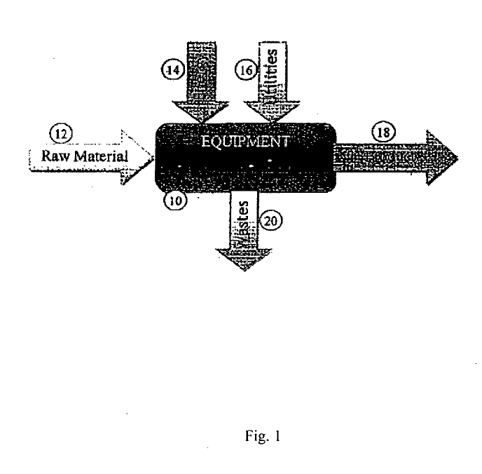

As shown in FIG. 1, in one embodiment of these teachings, according to the method of these teachings equipment is treated as a “black-box” that consumes energy and utilities and to convert certain defined inputs into certain defined outputs and creating some wastes in the process.

The method of these teachings monitors the equipment by measuring the parameters that provide data analysis of equipment's performance and efficiency. The above disclosed framework, shown in FIG. 1, allows equipment experts to configure the parameters that are measures of:
Equipment specific parameters that are useful in deriving the performance and efficiency (10), those that describe the equipment's instance specific operations & maintenance practices, instance or application specific configuration/set-point values that are different from those configured by default for the entire class and those that describe the ambient conditions under which equipment is operating:
The inputs to the equipment (12);
The energy consumed by the equipment (14);
The utilities consumed by the equipment (16);
The output produced by the equipment (18);
The wastes resulting from the process (20).

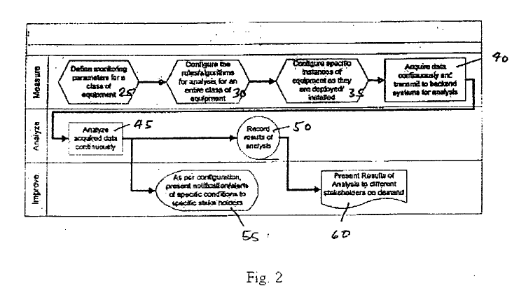

A flowchart description of an embodiment of the method of these teachings is shown in FIG. 2. Referring to FIG. 2, the method includes defining monitoring parameters for a class of equipment in the installed base (Step 25, FIG. 2). The rules/algorithms for analysis for an entire class of equipment are configured (step 30, FIG. 2) and the specific instances of equipment, as they are installed are also configured (step 35, FIG. 2). The data is continuously acquired and transmitted to backend (remote) systems for analysis (step 40, FIG. 2). In one instance, the data is transmitted over a network such as the Internet. An advantageous feature of the present invention being the provision for multiple modes of transmission of the acquired data in that on occurrence of failure of a given mode of transmission the system is automatically capable of switching to an alternative mode of transmission so that transmission takes place smoothly. The acquired data is analyzed (continuously, in one instance) (step 45, FIG. 2). From the results of the analysis of the acquired data, notifications/alert of specific conditions can be provided to specific stakeholders (step 55, FIG. 2), such as, but not limited to, OEMs, end users, maintenance & post sales services providers and others. The results of the analysis can be recorded (step 50, FIG. 2) and presented to different stakeholders, such as, but not limited to, OEMs, end users, maintenance and post sales service providers and others, on demand (step 60, FIG. 2). The analysis results when provided to OEMs enable continuous design improvements.

The “measuring” step of the method of the present teachings ensures that the data that is relevant for design verification/validation, performance analysis, equipment operations management and maintenance and service planning and scheduling is accurately and continuously captured.

In one embodiment, the method of these teachings allows engineering experts to determine which parameters are required to derive equipment performance and efficiency. In order to be efficient in data acquisition, in one instance, the method of these teachings provides multiple methods of data acquisition. In one embodiment, the method of these teachings supports the following different modes for acquiring the parameter values on ongoing basis:
Configured “set-points” that are common to the entire family of the equipment;
Configured “set-points”, those are specific to particular instances of installed equipment (either over-riding the global values set for the entire family or additional values that are relevant to specific instances). This allows for capturing of instance specific data and analysis of the impact on equipment performance of the specific data instances;
Directly from the equipment's control system (in situations where the control system is enabled with interfaces to share data);
Directly from sensors, meters and instruments, this is to support those parameters that are required for measurement of performance and efficiency but are not relevant for equipment operations and controls, and therefore may not be available from the control system;
Through manual entry with web or handheld devices (including mobile phones) based interfaces, for parameters that are either not available in an automated manner due to cost of sensors, or due to technical feasibility issues
In form of “derived parameters” (Parameters that are derived as a result of calculations performed on some other parameters and/or equipment set-points).

The present teachings provide for configuration of the entire eco-system by creating various hierarchies for classification of the acquired data with which the data can be analysed and the results of the analysis can be provided to various stakeholders. In one embodiment, the method of these teachings supports the following different modes for configuration
Site configurator with which the user can create a hierarchy in terms of geography, country, region, state, area and city.
User configurator with which the user can create a hierarchy in terms of end user, site, plant, area, unit & equipment.
Equipment model configurator with which the user can create a hierarchy in terms of the equipment model, assembly, sub assembly, component & sub component.

The above disclosed framework further allows equipment experts to configure the rules/algorithms for interpreting the acquired values individually or in pre-defined or ad-hoc co-related groups on an ongoing basis, and conversion of the same into meaningful and actionable information.

All interpretation/analysis rules/algorithms that are configured are executed on automated ongoing basis.

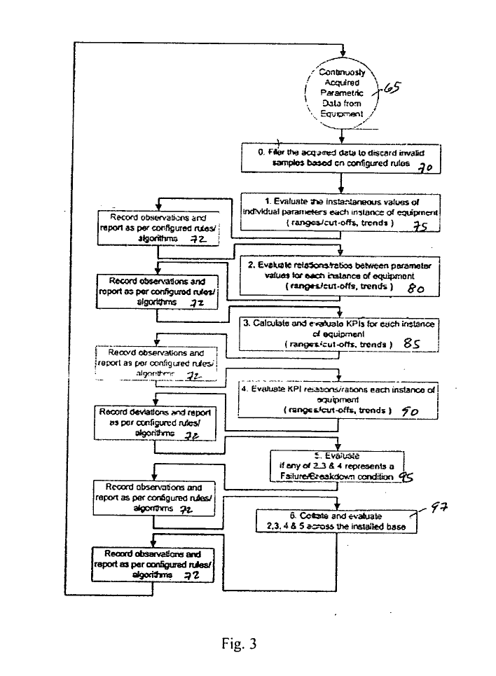

The “analysis” step of the method comprehensively examines captured data, from the perspective of identifying factors that affect performance and that are further useful in improving equipment operations, maintenance and service planning. The “analysis” step is not limited by known knowledge or by availability of expert at specific time etc. A flowchart description of the details of the analysis step of an embodiment of the method of these teachings is shown in FIG. 3. Referring to FIG. 3, the acquired data 65 is filtered in order to substantially describe invalid samples based on the configured rules (step 70. FIG. 3). From the filter data, the substantially instantaneous values of individual parameters are evaluated for each instantiation of the equipment (step 75. FIG. 3). The relationship/ratios between parameter values are evaluated for each instantiation of the equipment (step 80, FIG. 3). The key performance indicators (KPI) are calculated and evaluated for each instantiation of the equipment (step 85, FIG. 3). Key performance indicators relationship/ratios are evaluating for each instantiation of the equipment (step 90, FIG. 3). Whether or not the results of steps 75, 80, 85 or 90 represent a failure/breakdown condition is determined (step 95, FIG. 3). Steps 80, 85, 90 and 95 are repeated over the installed base of equipment and the results collated (step 97, FIG. 3). For each of the instantiation of the installed equipment and for the collated data from the plurality of pieces of equipment, each one piece of equipment from said plurality of pieces of equipment belonging to an installed base of a same class equipment, evaluating from the analysis results the performance, efficiency and reliability of each of the instantiation of the equipment and the equipment class. At each of steps 75, 80, 85, 90, 95 and 97, the observations are recorded and reported according to the configured rules/algorithm (step 72, FIG. 3).

This analysis is based on correlating the various parameters of data acquired from the plurality of equipment and identification of specific patterns and relations. These patterns and relationships are in the form of comparison/evaluation of measurements over a period of time and on occurrences of specific events.

Each of the parameter from the acquired data is evaluated against certain configured values and ranges, and based on the results of comparisons; the system triggers further analysis steps or notification of deviations as per configured rules.

The parameters are collated over pre-configured periods of time (e.g. average over a fixed period etc.): these are then compared with similar values of one more other parameters. If deviations from pre-configured limits/ranges are observed, the system records these deviations. The system records all occurrences of such deviations, along with snapshots of parametric data recorded at the time of such occurrences. The system also trends the changes in specific values, ratios between specific parameters or observed deviations over a period of time. The trend itself is examined and matched against pre-configured trends/curves and mismatches/deviations are recorded and acted upon as per configured rules/algorithms. All of the above steps being carried out for each of the instantiation of the equipment as well as over a plurality of equipments belonging to the same class and which may be present at multiple geographic locations.

The equipment experts create and configure rules/algorithms that automate the process of interpreting the data and its analysis as described above, and conversion of the same into meaningful and actionable information. The step of providing the analysis results to stakeholders ensures that the analyzed information and its interpretations are conveyed/presented correctly and automatically to the relevant stakeholders in a format that can be customized to the requirements of the concerned stakeholder. This includes reports, dashboards and other visual data representation tools that give insights into the equipments current status and its productivity, utilization and efficiency. This also includes the logic of identification of specific occurrences or of specific conditions or of specific performance indicators (KPIs, e.g. Overall Equipment Effectiveness—OEE, or specific energy consumption of equipment etc.) and trends in the observed values of the same. Generating various performance, utilization and efficiency dashboards, reports, alerts etc. for owners of equipment to optimize equipment operations, effectively optimize the OPEX/TCO (operational expenditure/total cost of ownership) of the equipment. Co-relation of equipment output production with energy and utilities consumption, and identification of patterns and deviations in the same results in improved energy efficiency of the equipment. Accurate equipment performance and efficiency data allows equipment owners/users to accurately account for cost of the engineering function performed by the monitored equipment.

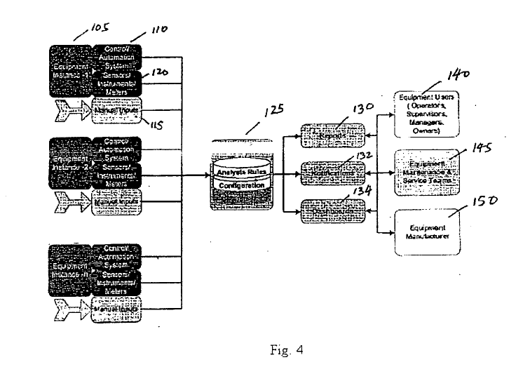

A block diagram representation of an embodiment of the system of these teachings is shown in FIG. 4. Referring to FIG. 4, a number of pieces of equipment, each piece of equipment 105 being an instantiation of a piece of equipment from an installed base, are monitored (parameter values are acquired) by means of a control automation system 110, or sensor/instruments/meters 120, or by entry of the desired parameters 115. The acquired data is provided to a remote or backend system 125 and reports 130 and/or notifications 132 and/or dashboards 134 are obtained and provided to equipment manufacturers (OEMs) 150 and equipment maintenance and service teams 145 and the equipment users 140.

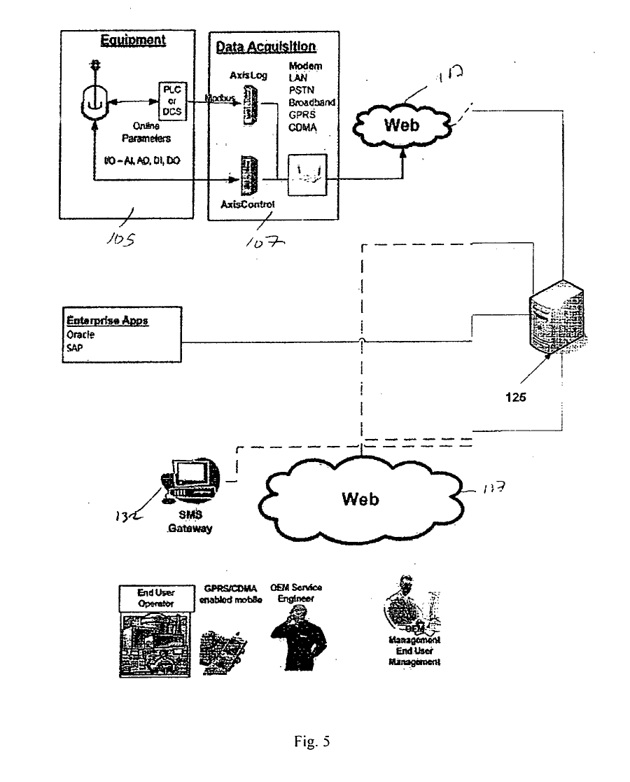

Another block diagram representation of an embodiment of the system of these teachings is shown in FIG. 5. Referring to FIG. 5, parameters are monitored from each piece of equipment 105 from a number of pieces of equipment (only one shown), each piece of equipment 105 being an instantiation of a piece of equipment from an installed base, by means of a data acquisition component 107. The data acquisition component is interfaced to a network 117 (exemplary modes of interfacing, not a limitation of these teachings, are listed) and connected via the network 117 to a remote or backend system (or server) 125. The remote or backend system 125 is interfaced via a network 117 or other means to end user operators or OEM representatives (such as OEM service engineers or OEM management) in order to provide the results of the analysis of the acquired data. The said results thus enabling the OEM in bringing about improvements in design of the equipment on a continuous basis and also the other respective stakeholders in better management of operations, maintenance and servicing of the given equipment(s).

The method of these teachings identifies the following as opportunities for improvement:
Equipment conditions under which changes in Overall Equipment Effectiveness (OEE) are observed:
Equipment conditions under which optimal (minimum deviation from design and/or configured levels) consumption of energy is observed;
Equipment conditions under which optimal consumption of utilities is observed;
Equipment conditions under which optimal rate of production of output is observed;
Equipment conditions under which minimum deviation from designed/configured output characteristics are observed;
Equipment conditions under which equipment failure rate is observed to be at or below the designed or configured rates;
Equipment conditions that are co-related to the instances to instances of failure, including historical analysis providing frequency distribution of common factors (in terms of parameter values) co-related with instances of equipment failure or breakdown across the entire installed base;
Identification of characteristics of wastes that indicate opportunities for recycling.

The “Improve” step of the method provides the outputs of the interpretation rules and analysis in various formats (visual/tabular/exported/transmitted etc.) to different defined stakeholders (equipment manufacturer's design team, maintenance/service teams, owners'operators etc.). The formats in which the output is provided to the stakeholders are customized in accordance with the specific requirements and configurations of the recipient stakeholder. Thus, the invention is capable of providing only the desired and relevant information in the most suitable format depending on the defined recipient stakeholder so that the information can be acted upon as necessitated.

The concerned stakeholders will bring about improvements in equipment performance & design in the following manner

Improved Equipment Performance: The equipment Key Performance Indicators which are calculated for each equipment are collated and analysed for all instances of the equipment across the installed base with respect to various patterns, correlations and scenarios which are defined as part of the configuration step such as input characteristics (e.g. specifications of raw material and utilities, specifications of the output produced by the equipment); operating conditions (e.g. ambient conditions at specific geographical locations); operations and maintenance procedures (e.g. automated, manual etc.); application specific configurations and integration (recipes, process specific configurations etc.).

For example, the end user configurator provides the kind of end user or industry where the equipment is operating. The site configurator provides the geography information of the installation.

The equipment performance parameters for the entire class of equipment installed base such as efficiency and performance are plotted against variables such as end user application, geography, fuel type etc. Various analysis techniques can be used for the same such as regression analysis, scatter diagrams, histograms etc. Based on this, equipment signature can be plotted and deviations from this signature can be tracked to further analyse deviations from the expected, average or best in class performance.

Most equipment users or OEM's don't realize how their equipment performance compares in terms of energy usage and efficiency because they don't have key information about how their equipment is performing over a period of time. Various Key Performance Indicators such as Energy Efficiency, MTBF (Mean Time Between Failures) can be benchmarked by comparing it with past performance, industry average or best in class. The KPI for each equipment in the installed base can be collated and analysed vis a vis the benchmark.

The performance monitoring & benchmarking which is done as described above, can be used to drive performance improvements for individual equipment users. The know ledge which is accumulated is used by the equipment experts at the OEM to analyse, troubleshoot, and suggest equipment operation, maintenance or service processes and practices which can bring about the desired improvements.

Improved Equipment Reliability: One of the techniques used for analysing equipment reliability is fault tree analysis. The equipment design experts create FTA's for each component, assembly and sub assembly and define the possible root cause of failures. These FTA's can be inputted to the software analysis package, and the data collected from across the installed base can be used to monitor specific occurrences of the conditions which could lead to equipment or component failure. Various rules and algorithms can be configured to monitor the occurrences of these conditions. This analysis can further be used to bring about improvements in the component design, or in overall system design, or in suggesting changes to the operation, maintenance or service of that component which can prevent such as failure.

Improved Equipment Design: Usually based on field service feedback, the product changes are undertaken. However these are based on individual unit observation summation and interpretations by the team of service people. Thus they are not comprehensive and result in many reiterations before these are stabilized. As such changes are costly and are of long cycle. When installed based is continuously monitored comprehensively as proposed, the analytics is exhaustive and could be made available to all the OEM functionaries like: R&D, Engineering, Materials, Manufacturing, and QA/QC. When coupled with service process data, the changes can be undertaken without going through the design reiterations.

Plurality of pre-determined equipment models of varying age depending on when they were deployed in the field can be monitored. These equipment models could be compared in terms of assembly, sub-assembly and components. Since the parameters from the equipment are mapped to the component, sub-assembly and assembly, it is possible to collect and analyse data on actual performance of these across the installed base.

For example, specific heavy oil filtering system could consist of variety of filtration, piping, type of filter, as well as mesh of the filter as well as centrifuging s′ stem. Based on the data available from variety of designs & models which are in the installed base, a selection could be made using the best performing design and a major design change can be made, to standardize on the most efficient system.

Similarly, materials function usually selects more than one vendor and the selection is based on testing against design specification by the vendor as well as testing by in house QA/QC. Installed base data can be analysed with respect to component makes, vendor source, with uniformly applied service and operating conditions to make changes to component source.

Certain critical manufacturing processes such as welding, heat treatment, machining can lead to product failures over a period of time. Continuous monitoring of installed base provides field failure data patters to be recognized. Further specific changes made to overcome these defects can continue to be monitored across the installed base to get insights for improvements in manufacturing processes.

Design, material and manufacturing process changes will also result in corresponding changes to the QA/QC procedures and their verification can be done by monitoring the installed base.

It should be noted that these teachings are capable of producing a variety of other analysis results.

Although these teachings have been described with respect to various embodiments, it should be realized these teachings are also capable of a wide variety of further and other embodiments within the spirit and scope of this

1-19. (canceled)

20. A method for improving design of equipments from equipment installed base, the method comprising the steps of:
i. acquiring a plurality of pre-defined parameters from equipment installed base located at multiple geographic locations, each one piece of equipment belonging to the same class equipment of equipment installed base;
ii. communicating by way of a communication network of remote system to acquire data, the remote system comprising a device having at least one data server, application server and one or more processors wherein the pre-defined parameters is recorded;
iii. processing and analysing the acquired data by the device, the analysis results being stored in an internal or external storage device of the remote system; and
iv. providing the analysis results to at least one of desired stakeholders;
the patterns and relations of the analysis results being used to improve the design of the equipments.

21. The method of claim 20, further for improving operation, reliability, maintenance and service for equipment installed base.

22. The method of claim 20, wherein the plurality of pre-defined parameters is acquired in a desired manner on a continuous basis.

23. The method of claim 20, wherein the plurality of pre-defined parameters is acquired in intervals which can be configured by the stakeholders.

24. The method of claim 20, wherein the plurality of pre-defined parameters is acquired on occurrence of a defined event or on request obtained from the stakeholder.

25. The method of claim 24, wherein the defined event comprises occurrence of any of events such as equipment failure, pre-defined equipment condition, pre-defined deviation of any of parameter value from the configured set-points of the installed equipment, and/or the configured instance specific set-points of the installed equipment.

26. The method of claim 20, wherein the step of acquiring the data utilizes at least one of:
i. configured set points of the installed equipment that are common to the entire family of the same class equipment;
ii. configured set points of the installed equipment, those are specific to particular instances of installed equipment;
iii. directly from the equipment control system;
iv. directly from sensors, transducers, meters and instruments;
v. derived parameters, the derived parameters comprising parameters obtained as a result of manipulation of at least one of other acquired parameters and/or the equipment set-points of the installed equipment;
vi. manually inputting parameters through an interface provided for said purpose, the said interface comprising web-enabled devices.

27. The method of claim 20, wherein the plurality of pre-defined parameters acquired comprise that are relevant for measurement of performance and efficiency of each one of a plurality of equipment installed base, each one piece of equipment belonging to the same class equipment from said plurality of equipment installed base.

28. The method of claim 20, wherein the plurality of pre-defined parameters acquired comprise any of equipment operating conditions, equipment environment conditions, input data and output data, energy consumed by the equipment, utilities consumed by the equipment, wastages resulting from the process.

29. The method of claim 20, wherein the patterns and relations of analysis results comprise factors affecting performance, efficiency and reliability.

30. The method of claim 20, wherein the step of providing includes providing the analysis results in at least one of the plurality of formats such as graphical user interface, charts, tabular, printed.

31. The method of claim 20, wherein the step of providing includes providing the analysis results of the remote system on request/demand obtained from user.

32. The method of claim 20, wherein the step of providing includes providing the analysis results of the remote system on occurrence of a defined event.

33. The method of claim 32, wherein the defined event comprises occurrence of any of events such as equipment failure, pre-defined equipment condition, pre-defined deviation of any of parameter value from the configured set-points, and/or the configured instance specific set-points of installed equipment.

34. The method of claim 20, wherein the step of providing includes providing the analysis results of the remote system on continuous/ongoing basis.

35. The method of claim 20, wherein the step of providing the analysis results includes transmitting in a selectable format, the format being customized according to the intended recipient stakeholder, the analysis results to the desired stakeholder by wireless means such as SMS, or an open network, wherein the open network is the interne.

36. The method of claim 20, wherein the step of analyzing further comprises the steps of:
i. filtering the acquired data according to configured logic, to substantially discard irrelevant data;
ii. storing the said data obtained by filtering in storage means provided for said purpose, said storage means comprising any of data servers, application server.
iii. evaluating, from the filtered data of each of the instantiation of the installed equipment substantially instantaneous values of individual parameters;
iv. evaluating relationship/ratios between the parameter values for each of the instantiation of the equipment;
v. calculating and evaluating key performance indicators those relevant to performance, efficiency and reliability for each instantiation of the equipment;
vi. evaluating the relationship/ratios between the key performance indicators, for each of the instantiation of the equipment;
vii. determining, from the results obtained from the aforesaid steps of analysis, condition of failure or breakdown;
viii. evaluating based on the data obtained, for each of the instantiation of the installed equipment and the collated data from the equipment installed base, each one piece of equipment from said equipment installed base belonging to same class equipment, the performance, efficiency and reliability of each of the instantiation of the equipment and the equipment class;
ix. repeating the above steps over a period of time and collating the results data;
x. recording the results data and the parameter data, relationship/ratios data, key performance indicator data in at least one data storage means such as server;
xi. reporting according to the configured rules the said results data and optionally the other data to the at least one desired stakeholder.

37. The method of claim 36, wherein the step of evaluating the filtered data further comprises evaluating by comparison each of the parameter against certain pre-configured values and/or range of values, whereby deviations, if any, from the pre-configured limits/ranges is determined, further recording each of the occurrence of such deviation/s along with the acquired parametric data at the given instance of each such deviation and optionally determining tendency in the changes in the substantially instantaneous values, relationship/ratios between any of the acquired parameters, observed deviations in such values.

38. The method of claim 21, wherein the plurality of pre-defined parameters is acquired in a desired manner on a continuous basis.

39. The method of claim 21, wherein the plurality of pre-defined parameters is acquired in intervals which can be configured by the stakeholders.

40. The method of claim 21, wherein the plurality of pre-defined parameters is acquired on occurrence of a defined event or on request obtained from the stakeholder.

41. The method of claim 21, wherein the plurality of pre-defined parameters is acquired on occurrence of a defined event or on request obtained from the stakeholder.

42. The method of claim 41, wherein the defined event comprises occurrence of any of events such as equipment failure, pre-defined equipment condition, pre-defined deviation of any of parameter value from the configured set-points of the installed equipment, and/or the configured instance specific set-points of the installed equipment.

43. The method of claim 21, wherein the step of acquiring the data utilizes at least one of:
i. configured set points of the installed equipment that are common to the entire family of the same class equipment;
ii. configured set points of the installed equipment, those are specific to particular instances of installed equipment;
iii. directly from the equipment control system;
iv. directly from sensors, transducers, meters and instruments;
v. derived parameters, the derived parameters comprising parameters obtained as a result of manipulation of at least one of other acquired parameters and/or the equipment set-points of the installed equipment;
vi. manually inputting parameters through an interface provided for said purpose, the said interface comprising web-enabled devices.

44. The method of claim 21, wherein the plurality of pre-defined parameters acquired comprise that are relevant for measurement of performance and efficiency of each one of a plurality of equipment installed base, each one piece of equipment belonging to the same class equipment from said plurality of equipment installed base.

45. The method of claim 21, wherein the plurality of pre-defined parameters acquired comprise any of equipment operating conditions, equipment environment conditions, input data and output data, energy consumed by the equipment, utilities consumed by the equipment, wastages resulting from the process.

46. The method of claim 21, wherein the patterns and relations of analysis results comprise factors affecting performance, efficiency and reliability.

47. The method of claim 21, wherein the step of providing includes providing the analysis results in at least one of the plurality of formats such as graphical user interface, charts, tabular, printed.

48. The method of claim 21, wherein the step of providing includes providing the analysis results of the remote system on request/demand obtained from user.

49. The method of claim 21, wherein the step of providing includes providing the analysis results of the remote system on occurrence of a defined event.

50. The method of claim 49, wherein the defined event comprises occurrence of any of events such as equipment failure, pre-defined equipment condition, pre-defined deviation of any of parameter value from the configured set-points, and/or the configured instance specific set-points of installed equipment.

51. The method of claim 21, wherein the step of providing includes providing the analysis results of the remote system on continuous/ongoing basis.

52. The method of claim 21, wherein the step of providing the analysis results includes transmitting in a selectable format, the format being customized according to the intended recipient stakeholder, the analysis results to the desired stakeholder by wireless means such as SMS, or an open network, wherein the open network is the internet.

53. The method of claim 21, wherein the step of analyzing further comprises the steps of:
i. filtering the acquired data according to configured logic, to substantially discard irrelevant data;
ii. storing the said data obtained by filtering in storage means provided for said purpose, said storage means comprising any of data servers, application server.
iii. evaluating, from the filtered data of each of the instantiation of the installed equipment substantially instantaneous values of individual parameters;
iv. evaluating relationship/ratios between the parameter values for each of the instantiation of the equipment;
v. calculating and evaluating key performance indicators those relevant to performance, efficiency and reliability for each instantiation of the equipment;
vi. evaluating the relationship/ratios between the key performance indicators, for each of the instantiation of the equipment;
vii. determining, from the results obtained from the aforesaid steps of analysis, condition of failure or breakdown;
viii. evaluating based on the data obtained, for each of the instantiation of the installed equipment and the collated data from the equipment installed base, each one piece of equipment from said equipment installed base belonging to same class equipment, the performance, efficiency and reliability of each of the instantiation of the equipment and the equipment class;
ix. repeating the above steps over a period of time and collating the results data;
x. recording the results data and the parameter data, relationship/ratios data, key performance indicator data in at least one data storage means such as server;
xi. reporting according to the configured rules the said results data and optionally the other data to the at least one desired stakeholder.

54. The method of claim 53, wherein the step of evaluating the filtered data further comprises evaluating by comparison each of the parameter against certain pre-configured values and/or range of values, whereby deviations, if any, from the pre-configured limits/ranges is determined, further recording each of the occurrence of such deviation/s along with the acquired parametric data at the given instance of each such deviation and optionally determining tendency in the changes in the substantially instantaneous values, relationship/ratios between any of the acquired parameters, observed deviations in such values.
